(19) United States
(12) Patent Application Publication
(10) Pub. No.: US 2018/0047021 A1
(43) Pub. Date: Feb. 15, 2018

(54) SYSTEM AND METHOD FOR TOKEN-BASED TRANSACTIONS

(71) Applicant: MasterCard International Incorporated, Purchase, NY (US)

(72) Inventors: Gautam Uppalapati, O'Fallon, MO (US); Joshua Nathan Anderson, St. Peters, MO (US); Smita Sebastian, Chesterfield, MO (US)

(21) Appl. No.: 15/231,978

(22) Filed: Aug. 9, 2016

(51) Int. Cl. G06Q 20/40; G06Q 20/38

(52) U.S. Cl. CPC G06Q 20/409; G06Q 20/385

(57) ABSTRACT

Provided are a system and methods for reducing the amount of payment information stored by a merchant. In one example, a method includes receiving payment card information of a cardholder from a payment information receiving module displayed in a web browser of a computing device, generating a token for the payment card information received from the payment information receiving module, and transmitting the generated token to a merchant server for a transaction between the merchant and the cardholder. According to various aspects, the payment information receiving module is displayed in the web browser of the computing device in response to a merchant website being displayed therein, and the payment card information is received by the payment processing server, from the payment information receiving module, without being stored by the computing device and without passing through the merchant server.

### FIELD

Exemplary embodiments described herein relate generally to performing web-based transactions and, more particularly, to systems and methods for tokenizing payment information for web-based transactions using a payment information receiving module.

### BACKGROUND

A significant amount of transactions now occur electronically over the Internet, for example, through a web browser on a consumer's computer or a merchant controlled computer. A merchant may host a website that lists the merchant's products and which enables the consumer to browse the website and shop for items of interest. Some merchants, such as insurance companies, retail companies, and the like, may also disburse funds to consumer payment cards. In order to electronically disburse funds, the consumer or the merchant must typically enter payment card information of the consumer on a page of the merchant website. The payment information may be submitted to a payment network for verification. Once it is verified, the payment network may disburse funds to the payment card of the consumer and transmit a disbursement completion confirmation to the merchant website. In some cases, the merchant website may generate a confirmation page for the consumer showing a summary of the disbursement. In a typical electronic disbursement, a merchant or a merchant server receives disbursement information such as a payment card number, expiration date, CVC number, and the like, as well as other personal information such as a name, an address, phone number, and the like. At a minimum, the payment disbursement information must pass through the merchant's computer and/or server. In addition, a merchant may typically store some or all of this consume payment data on a merchant server and the data may remain on the merchant server even after the transaction occurs.

Payment card information and personal information received and/or stored by a merchant is protected by the Payment Card Industry Data Security Standard (PCI DSS) or more simply (PCI). PCI is a set of requirements designed to ensure that all organizations that process, store, or transmit payment card information maintain a secure environment. In order to be PCI compliant, an organization must perform a number of duties including periodic vulnerability scans to ensure that data is secure. Organizations that are found to be out of compliance with PCI may be subject to fines by the entity they use to process their payment card transactions. Also, organizations that have a data breach where payment card data is stolen are subject to much larger fines and fees from the banks, card brands, etc., and are required to report the breach, which can cause further reputational damage.

When organizations store payment card data within their own databases, they significantly increase their requirements under PCI because a breach of their database can compromise an entire set of payment card data. Furthermore, organizations which merely allow payment card information to pass through their servers without being stored in their databases may reduce overhead but they are still subject to some PCI compliance because the payment card data may be captured from log files on the server or otherwise be susceptible to unauthorized programs or attacks which have infiltrated the merchant server.

### BRIEF DESCRIPTION OF THE DRAWINGS

Features and advantages of the exemplary embodiments, and the manner in which the same are accomplished, will become more readily apparent with reference to the following detailed description taken in conjunction with the accompanying drawings.

FIG. 1A is a diagram illustrating an overview of a token generating system generating tokenized payment information in accordance with an exemplary embodiment.

FIG. 1B is a diagram illustrating an overview of the token generating system generating tokenized payment information in a multi-step process in accordance with an exemplary embodiment.

FIG. 2 is a diagram illustrating a payment information receiving module in accordance with an example embodiment.

FIG. 3 is a diagram illustrating a tokenization server in accordance with an example embodiment.

FIG. 4 is a diagram illustrating a tokenization method in accordance with an example embodiment.

FIG. 5 is a diagram illustrating a tokenization method in accordance with another exemplary embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various exemplary embodiments. It should be appreciated that various modifications to the embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

The exemplary embodiments described herein relate to a tokenization method that may be performed using a payment information capturing module. The payment information capturing module may relieve the burden on merchants and other vendors that accept payment cards and that distribute or disburse funds to payment cards of their customers without requiring the merchant to store the payment card information and without the payment information passing through a merchant server providing a merchant web page associated with the disbursement. In the example embodiments, a payment processing server such as provided by MasterCard, Visa, American Express, a third party payment processor, a bank, and the like, may generate a module that is displayed within a web browser of a client computing device. The module may be a Lightbox, an iframe, a floating module, or another type of widget that is capable of receiving input from a user. When the user navigates to a merchant website or selects an option on the merchant website, the module may automatically be displayed. The module may prompt the user for payment card information of a cardholder. In some cases, the user may be the cardholder or the user may be a different person than the cardholder. Rather than storing the payment card information at the client device or passing the payment card information through the merchant device, the payment card information may be transmitted directly from the web browser to the payment processing server. In response, the payment processing server may generate a token for the payment card information and transmit the token to the merchant browser which is subsequently captured by the merchant application and passed to the merchant server. Accordingly, the merchant may perform a web-based transaction for the cardholder such as a payment disbursement using the token even though the merchant server never received the payment card information of the cardholder.

In some embodiments, the tokenization method may include a two-step tokenization process in which a temporary token is established first, and a more permanent token or long term token for the cardholder is established second. The temporary token for the cardholder may be established by communication between a web browser running on a client device and a web-based server of the payment processor. Meanwhile, the more permanent token for the cardholder may be established directly between a merchant server and a server of the payment processor. Examples of the tokenization process are further described herein.

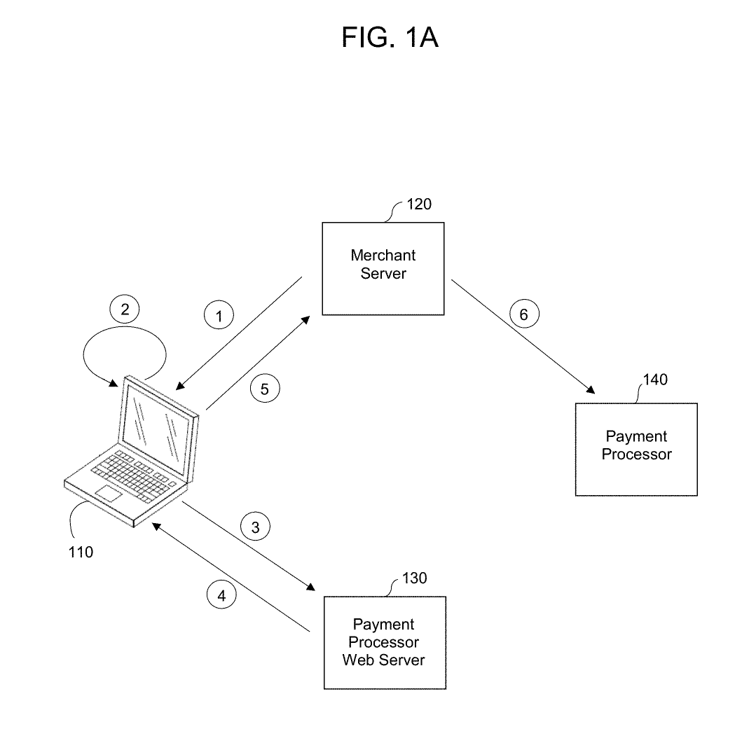

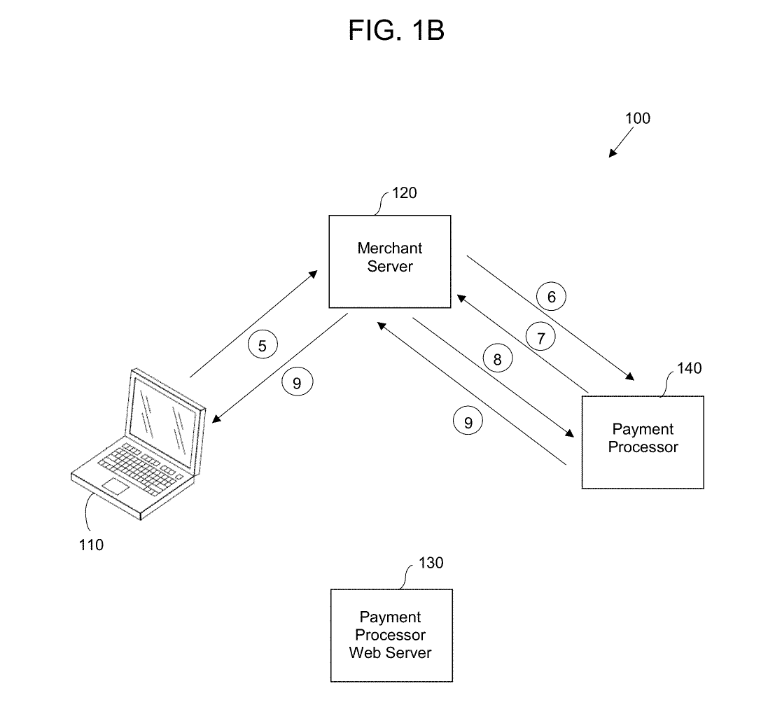

FIG. 1A illustrates an overview of a token generating system 100 for generating tokenized payment information in accordance with an exemplary embodiment. Referring to FIG. 1A, the token generating system 100 includes a user computing device 110, a merchant server 120, a payment processor web server 130, and a payment processor 140. In this example, the payment processor web server 130 and the payment processor 140 are shown as separate devices for convenience of explanation, but it should be appreciated that the two devices may be included in the same system, server, computer, and the like. In this example, the payment processor web server 130 and the payment processor 140 are connected to each other via a connection such as a wired connection, wireless connection, or combination thereof.

For example, the merchant in FIG. 1A may be an insurance company, however, the embodiments are not limited thereto, and any merchant or organization may be used. In this example, the user computing device 110 may correspond to a computing device of an insurance agent, a customer of the insurance company, and the like. A web browser is displayed on the user computing device 110. For example, the web browser may be Microsoft Internet Explorer, Apple Safari, Google Chrome, and the like. A user of the user computing device 110 may enter an address (e.g., URL) of a merchant website provided by the merchant server 120 into the web browser of the user computing device 110. In some cases, the user computing device 110 may be controlled by the merchant or may be a computing device of the merchant. The merchant website may be provided from the merchant server 120 within the web browser of the user computing device 110, as shown in step 1. In the example of the insurance company, the user computing device 110 may be the computing device of an insurance agent of the insurance company, a customer of the insurance company, and the like. For example, the insurance agent may enter an address of a website of the insurance agency or the customer may enter an address of the insurance agency's website into the web browser. In response, the website of the insurance agency may be provided in the web browser of the user computing device 110.

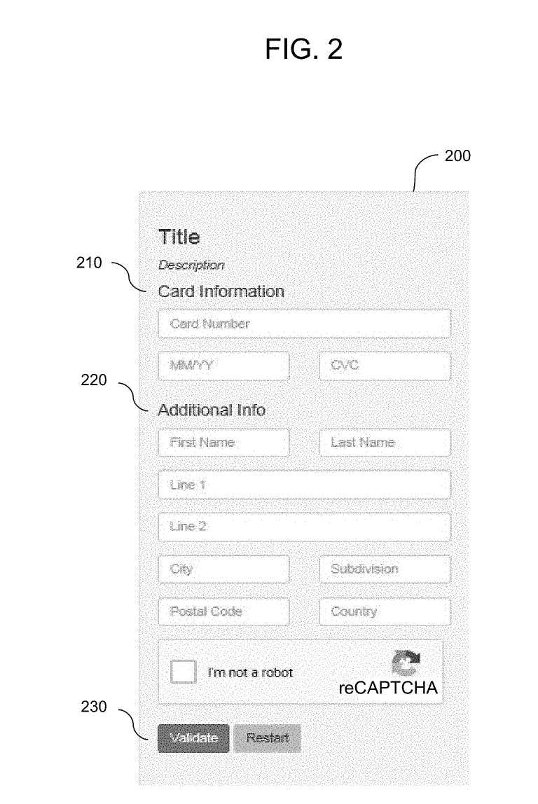

In response to a condition being satisfied, for example, the merchant website being displayed within the web browser, the user navigating to a particular web page of the merchant website, the selection of an option or choice on the merchant website, and the like, a payment information receiving module is generated and displayed on the user computing device 110, in step 2. As another example, the payment information receiving module may automatically be provided in step 2 without a condition being satisfied. As a non-limiting example, the payment information receiving module may be a lightbox, an iframe on a web page, a floating module, and the like. The payment information receiving module may be generated, opened, executed, displayed, and/or the like, based on code such as code from a JavaScript library which is embedded within or added to the merchant website. The payment information receiving module may be displayed in various formats such as embedded within the website, as an overlay on top of the website, and the like. An example of the payment information receiving module is shown and described with respect to FIG. 2, and is further described below. Referring again to FIG. 1A, when the user enters an address of the merchant website into a search bar or a status bar of the web browser, the merchant server 120 may transmit a copy of the merchant website to the web browser. In response, the payment information receiving module may be displayed in the web browser. As another example, the user may navigate through the merchant website and select and “DISTRIBUTE FUNDS” option or “SEND MONEY” option, and the like, within the merchant website. In response, the payment information receiving module may be displayed.

The user may enter payment card information into fields of the payment information receiving module displayed in step 2. FIG. 2 illustrates a lightbox being used as a payment information receiving module 200 in accordance with an example embodiment. Referring to FIG. 2, the lightbox 200 includes fields for receiving payment card information 210 which may include one or more of a primary account number (PAN), an expiry, a secure code (e.g., CVC, CVV, and the like), cardholder information, and the like. The payment information receiving module 200 may also include an entry for additional information 220 including one or more of name, address, phone number, and the like. Furthermore, the payment information receiving module 200 may include a validate button 230 which may be selected to transmit the payment card information and the additional information to the payment processing web server 120. In the example of the insurance agent, the insurance agent may be conversing with a customer and may enter the customer's information into the payment information receiving module. As another example, a cardholder/customer may enter their payment card information using a personal computer while visiting a webpage of the insurance company.

Referring again to FIG. 1A, in step 3, the payment card information input into the payment information receiving module is transmitted to the payment processor web server 130 over a public network such as the Internet. According to various exemplary embodiments, the payment card information may be transmitted from the web browser of the user computing device 110 and received by the payment processor web server 130, via the payment information receiving module, without being stored by the user computing device 110 and without passing through the merchant server 120. That is, the payment information does not pass through the merchant server 120 even though the merchant website is causing the payment information receiving module to be generated and displayed. In the example of the merchant being the insurance company, the payment card information of a customer may be entered into and transmitted directly to the payment processor web server 130 without passing through or being stored on the insurance company's server, from a web browser which is running on a user's workstation of the insurance company. As a result of the payment information being transmitted directly to the payment processor without being stored by a merchant device, the merchant's PCI requirements may be alleviated or otherwise reduced. Accordingly, the merchant may save time and expense that it would expend to satisfy PCI compliance requirements.

The payment processor web server 130 may receive the payment card information and may validate the payment card information. For example, the payment processor web server 130 may validate a combination of payment card data such as PAN, expiry, security code, and the like, to determine whether the payment card information is valid. In response to determining that the payment card information is valid, the payment processor web server 130 may generate a token for the payment card information. For example, the token may be a random number having a format of valid payment card information such as a valid format of a PAN, an expiry, and the like. In some examples, the token may include a plurality of tokens representing a plurality of fields of payment card information. In step 4, the payment processor web server 130 transmits the token to the web browser of the user computing device 110. The token generated and transmitted in step 4 may be a temporary token as further described in the example of FIG. 1A. For example, the temporary token may be valid only for a predetermined amount of time, such as 1 minute, 30 minutes, one hour, one day, and the like. As another example, the temporary token may be valid for a predetermined number of uses, such as one use, five uses, ten uses, and the like. As another example, the temporary token may only be used to request a permanent token over a secure channel. As another example, the token generated and transmitted in step 4 may be a long term token.

In step 5, the user of the user computing device 110 may select additional data from the merchant website, and the like, and transmit the data along with the token to the merchant server 130 to request processing of a transaction. In the example of an insurance company, the requested transaction may be the distribution of funds such as an insurance claim, and the like. In step 6, the merchant server 130 may transmit a request for a transaction to be processed to the payment processor 140. In this example, the request may include the token representing the cardholder payment information for receiving the funds rather than transmitting the cardholder's actual payment card information. As a non-limiting example, the request may include a request to distribute funds from the merchant to the cardholder. Accordingly, the merchant may distribute funds to the cardholder without ever having to receive or store the cardholder's payment card details.

FIG. 1B illustrates the token generating system 100 generating tokenized payment information in a multi-step process in accordance with an exemplary embodiment. In this example, the token generated and transmitted to the user computing device 110 in step 4 (FIG. 1A) is a temporary token. The temporary token may have a limited amount of time that it is valid, a limited amount of uses, or a limited type of use. Likewise, the token received by the merchant server 120 in step 5 is the temporary token. In this example, the merchant server 120 transmits the temporary token to the payment processor 140 along with a request for a long term token, in step 6. According to various aspects, the long term token may be valid for a longer period of time than the short term token. For example, the long term token may have an unlimited amount of uses, or an unlimited time limit. In this example, the temporary token may only be used to request a long term or permanent token. That is, a type of use of the temporary token may be limited to requesting the longer term token only, and not for distributing funds or performing other transactions.

In response to receiving the request, the payment processor 140 validates the short term token and transmits the long term token to the merchant server 120 in step 7. The merchant server 120 may use the long term token as a way of identifying a primary account number of the cardholder for future transactions with the cardholder through the payment processor 140. In the example of FIG. 1A, the temporary token may be obtained over a public network such as the Internet. Accordingly, the temporary token may only be valid for a brief period of time or for a particular use. In this case, the merchant server 120 may transmit the request for the permanent token along with the temporary token to the payment processor 140 using a secure channel and may receive the long term token through the secure channel. Accordingly, using the two step token process the only token that may be exposed on the public network is the temporary token which has a temporary lifespan. Meanwhile, the permanent token may be requested and received on a secure channel. As a result, even if the temporary token is obtained by an unauthorized entity, the temporary token cannot be used to defraud the payment account because the payment can only be initiated over a secure channel. Also, the temporary token may have a configurable number of uses that are predefined to further prevent any unauthorized uses. The long term token may be used in step 8 to request a transaction from the payment processor 140 for the cardholder without divulging the cardholder's payment card information or personal information. Furthermore, the merchant server 120 and the payment processor 140 may store the long term token for future use. Upon processing of the transaction for the cardholder (e.g., successful or unsuccessful) a result may be transmitted to merchant server 120 and merchant server 120 takes action to provide result back to the user computing device 110 to update status to the user in step 9.

In the examples herein, the payment information receiving module may be controlled by the payment processor 140 and may be associated with the merchant website or web page provided by the merchant server 120. For example, the merchant website may have code embedded therein which causes the payment information receiving module to be displayed in the web browser of the user computing device 110. The code may be received from the payment processor 140, a browser providing server, a third party, and the like. In some examples, the payment information receiving module may be displayed in response to the merchant website being loaded and/or displayed by the web browser on the user computing device 110. As another example, the payment information receiving module may be displayed in response to the user selecting an option or navigating to a predetermined page on the merchant website. Furthermore, the merchant server 120 providing the web page may be the same server receiving the token, or it may be a different merchant computing device that is in communication with the merchant server 120 providing the web page. Furthermore, the payment processing server 140 may be a tokenization server, and the like, and may not be used for payment processing.

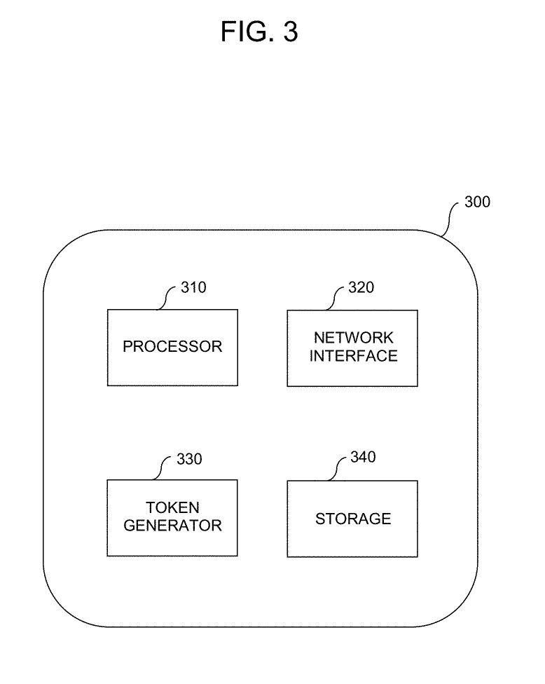

FIG. 3 illustrates a computing device 300 for performing tokenization in accordance with an example embodiment. For example, the computing device 300 may be one or more of the payment processor web server 130 and the payment processor 140, a token server, a payment network device, a payment gateway, and the like. Referring to FIG. 3, the computing device 300 includes a processor 310, a network interface 320, a token generator 330, and a storage 340. The processor 310 may include one or more processing devices each having one or more processing cores and may control the overall operations of the computing device 300. The network interface 320 may correspond to an interface capable of transmitting and receiving data over a network such as the Internet. Although not shown, the computing device 300 may also include a radio interface capable of transmitting and receiving data through radio signals, and the like. Also, it should be appreciated that the computing device 300 may include additional components not shown in FIG. 3, or may not include all of the components shown in FIG. 3.

In this example, the network interface 320 may receive payment card information of a cardholder from a web browser running on a client device such as user computing device 110 shown in FIG. 1. The payment card information may be received from a payment information receiving module running in the web browser. The payment information receiving module may be executed or initiated in the web browser in response to a merchant website being displayed in the web browser. That is, the merchant website may control the displaying of the payment information receiving module. According to various aspects, however, the payment card information may be received by the computing device 300, from the payment information receiving module executing on the client device, without being stored by the client device and without passing through a merchant server providing the merchant website. Accordingly, payment card information of a cardholder may be received via the payment information receiving module in order to settle a transaction between the merchant server and the cardholder.

In response to receiving the payment card information, the token generator 330 may generate a token for the payment card information corresponding to the cardholder. For example, the token may include a random number, a predetermined number, and the like. In some cases, the token may be a temporary token that is only valid for a limited amount of time and/or uses, or in a limited amount of situations. The token may be used to identify the payment card information of the cardholder with the computing device 300. The storage 340 may store mapping tables that include mapping information identifying a payment card number and other payment card information based on a token received from a merchant, issuer, payment network, third party, and the like. That is, the mapping tables may include information mapping PAN's to tokens based on a one-to-one basis, and the like. For example, each token may correspond to a respective PAN. The processor 310 may transmit the generated token to a merchant server for a transaction between the merchant and the cardholder. In some cases, the computing device 300 may receive a request to generate a long term token from the merchant server. For example, the initial token generated by the token generator 330 may be a temporary token. In response to receiving the request for the long term token, the token generator may generate a long term or permanent token and store the permanent token in the storage 340.

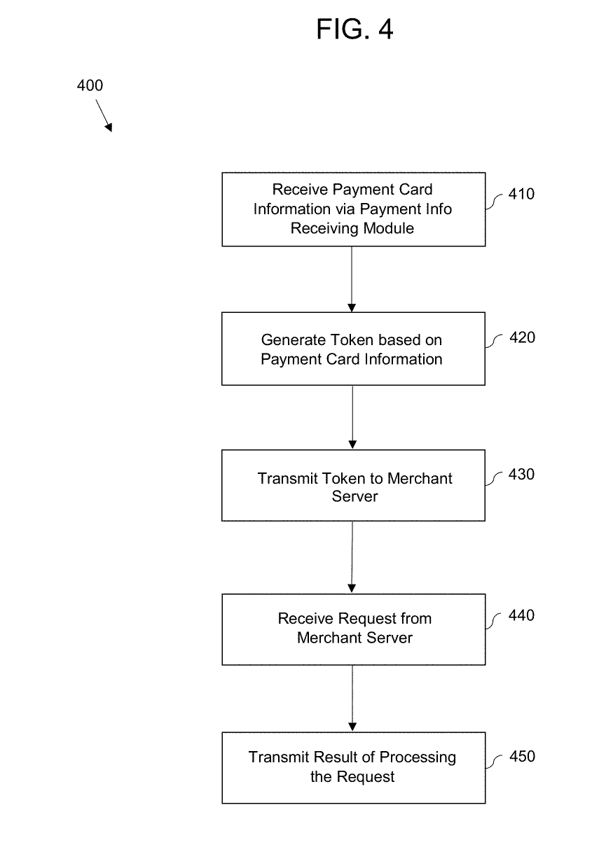

FIG. 4 illustrates a tokenization method 400 in accordance with an example embodiment. For example, the tokenization method 400 may be performed by one or more computing devices such as one or more of the payment processor web server 130 and the payment processor device 140 shown in FIG. 1, the computing device 300 shown in FIG. 3, and the like. Referring to FIG. 4, the method 400 includes receiving payment card information of a cardholder from a payment information receiving module that is running in a web browser of a client device, in 410. The client device may be a user computing device, a merchant controlled computing device, a cardholder computing device, and the like. For example, the payment information receiving module may be displayed in the web browser of the client device in response to a merchant website being displayed therein, and the payment card information is received by a payment processing server, from the payment information receiving module, without being stored by the computing device and without passing through the merchant server. Here, the payment information receiving module may include at least one of a Lightbox, a floating module, and an iframe. According to various examples, code for installing the payment information receiving module in a website may be transmitted to the merchant server and the code may be embedded in the merchant website by the merchant server such that when the merchant web site is displayed in the web browser of a client device, the payment information receiving module is also displayed.

The method 400 further includes generating a token for the payment card information received from the payment information receiving module, in 420. For example, the token may be generated by a payment processor or a token vault controlled by a payment processor. The token may be used to identify an account number and/or other payment information of a cardholder without divulging sensitive information. In some examples, the generated token may include a temporary token that is only valid for a predetermined amount of time. In 430, the method 400 further includes transmitting the generated token to the client browser on the user computing device for a transaction between the merchant and the cardholder. Here, the lightbox may capture information from the client browser and submit the information to the merchant server.

In 440, the method further includes receiving a request from the merchant server including the temporary token and additional credentials for processing a transaction. For example, the request may be a request to distribute funds to the cardholder from the merchant's account or for a permanent token to use for transactions. In response, the payment processor may determine whether the received token matches the generated token, and process the distribution request based on the determination. As another example, the token generated in 420 may be a temporary token. In this example, the request in 440 may include a request for a permanent token. In response, the payment processor may determine whether the received token matches the generated token and generate a permanent token based on the determination. In 450, the method 400 includes transmitting a result of processing the request in 440, to the merchant server.

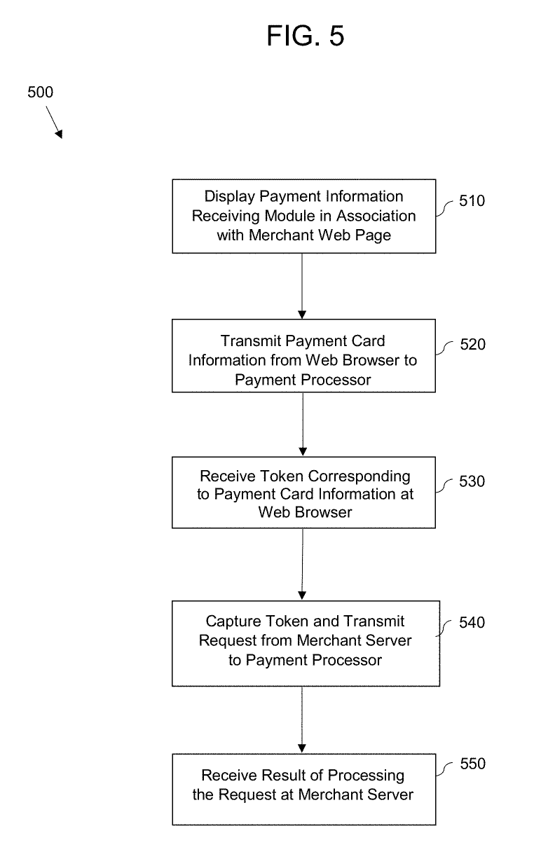

FIG. 5 is a diagram illustrating a tokenization method 500 in accordance with another exemplary embodiment. The example of FIG. 5 may be performed by a merchant server and a web browser on a client device. The client device may display a website of the merchant that is received from the merchant server. The client device may correspond to a merchant controlled device or it may be a cardholder's computing device. Referring to FIG. 5, the method 500 includes displaying, by the web browser, a payment information receiving module provided by a payment processing server in association with a merchant website provided by the merchant server, in 510. As an example, the payment information receiving module may include at least one of a Lightbox, a floating module, and an iframe. For example, the displaying in 510 may include simultaneously displaying the payment information receiving module and the merchant website within the web browser by embedding the payment information receiving module within the merchant website or by overlaying the payment information receiving module on top of the merchant website. Here, the method may further include installing, by the merchant server, code for displaying the payment information receive module along with the merchant web site, wherein the code is received from the payment processing server.

In 520, the method 500 includes transmitting, by the web browser, payment card information of a cardholder received via the payment information receiving module to the payment processor. The transmittal may be for a transaction between the cardholder and the merchant. In this example, the payment card information being transmitted from the web browser to a payment processing server is transmitted and received without being stored by the client device and without passing through the merchant server. Instead, the payment card information is received by the payment processor directly from the web browser on the client device. A token is then sent to the client browser running the merchant application (i.e., the payment information receiving module).

In 530, the method 500 further includes capturing, by the merchant server, a token corresponding to the payment card information of the cardholder from the client browser running the merchant application. In 540, the method 500 includes transmitting, by the merchant server to the payment processor, a request including the captured token, transaction details and security credentials. For example, the request may include a request to distribute funds to the cardholder corresponding to the payment card information. As another example, the request may include a request for a long term token. Next, in 550, the method 500 includes receiving, by the web browser via the merchant server, a result of processing of the request from the payment processing server.

According to various aspects, provided is a method of tokenizing payment card information using a payment information receiving module such as a lightbox. Rather than the payment card information being stored on a client device or passing through a merchant server, the payment card information receiving module is displayed along with a merchant website, and transmit the payment card information directly from a web browser to a payment processor. As a result, a merchant is not required to store payment card information of a cardholder in order to process a transaction for the cardholder such as the distribution of funds. In addition, the lightbox layout provides flexibility to control what fields are displayed on the lightbox in the client browser. Also using the information from the lightbox, the payment processor can perform an account eligibility check and account verification to validate the postal code or address provided by the consumer in the lightbox matches the card they provided.

As used herein and in the appended claims, the term “payment card account” includes a credit card account, a deposit account that the account holder may access using a debit card, a prepaid card account, or any other type of account from which payment transactions may be consummated. The term “payment card account number” includes a number that identifies a payment card system account or a number carried by a payment card, or a number that is used to route a transaction in a payment system that handles debit card and/or credit card transactions. The term “payment card” includes a credit card, debit card, prepaid card, or other type of payment instrument, whether an actual physical card or virtual.

As used herein and in the appended claims, the term “payment card system” or “payment system” refers to a system for handling transactions such as pushing funds to a payment card which is unique to the exemplary embodiments as well as purchase transactions such as receiving funds from a payment card. An example of such a system is the one operated by MasterCard International Incorporated, the assignee of the present disclosure. In some embodiments, the term “payment card system” may be limited to systems in which member financial institutions issue

As used herein, the terms card, transaction card, financial transaction card, payment card, and the like, refer to any suitable transaction card, such as a credit card, a debit card, a prepaid card, a charge card, a membership card, a promotional card, a frequent flyer card, an identification card, a gift card, and the like, and also refer to any suitable payment account such as a deposit account, bank account, credit account, and the like. As another example, the terms may refer to any other device or media that may hold payment account information, such as mobile phones, Smartphones, personal digital assistants (PDAs), key fobs, computers, and the like. The transaction card can be used as a method of payment for performing a transaction.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A tokenization method of a payment processing server, the method comprising:
receiving payment card information of a cardholder from a payment information receiving module displayed in a web browser of a computing device;
generating a token for the payment card information received from the payment information receiving module; and
transmitting the generated token to the web browser for a transaction between the merchant and the cardholder,
wherein the payment information receiving module is displayed in the web browser of the computing device in response to a merchant website being displayed in association therewith, and the payment card information is captured by the payment processing server, from the payment information receiving module, without being stored by the computing device and without passing through the merchant server.

2. The method of claim 1, wherein the computing device comprises a merchant computing device.

3. The method of claim 1, wherein the payment information receiving module comprises at least one of a Lightbox, a floating module, and an iframe.

4. The method of claim 1, further comprising:
receiving, by the payment processing server, a token and a request from the merchant server to distribute funds to the cardholder corresponding to the payment card information;
determining whether the received token matches the generated token; and
processing the distribution request based on the determination.

5. The method of claim 1, wherein the generated token comprises a temporary token that is only valid for a predetermined amount of time.

6. The method of claim 5, further comprising:
receiving, from the merchant server, the temporary token along with a request for a longer term token for the payment card information; and
in response, generating a permanent token for the payment card information and transmitting the permanent token to the merchant server.

7. The method of claim 1, further comprising transmitting, to the merchant server, code for installing the payment information receiving module in the website.

8. A tokenization method comprising:
displaying, by a web browser, a merchant website provided by a merchant server;
displaying, by the web browser, a payment information receiving module provided by a payment processing server in response to displaying the merchant website;
transmitting, by the web browser, payment card information of a cardholder received via the payment information receiving module for a transaction between the cardholder and the merchant, the payment card information being transmitted from the web browser to a payment processing server without being stored by the computing device and without passing through the merchant server; and
receiving, by the web browser, a token corresponding to the payment card information of the cardholder from the payment processing server.

9. The tokenization method of claim 8, wherein the computing device comprises a merchant computing device.

10. The method of claim 8, further comprising installing, by the merchant server, code for displaying the payment information receive module along with the merchant website, wherein the code is received from the payment processing server.

11. The method of claim 8, wherein the payment information receiving module comprises at least one of a Lightbox, a floating module, and an iframe.

12. The method of claim 8, further comprising:
transmitting, by the merchant server to the payment processing server, a request to distribute funds to the cardholder corresponding to the payment card information, the request comprising the received token; and
receiving, by the web browser, a result of processing of the distribution request from the payment processing server.

13. The method of claim 8, wherein the token comprises a temporary token that is only valid for a predetermined amount of time.

14. The method of claim 13, further comprising:
transmitting, by the merchant server, the temporary token along with a request for a long term token for the payment card information; and
receiving, by the merchant server, a permanent token for the payment card information, wherein the permanent token is valid for a greater amount of time than the temporary token.

15. The method of claim 8, wherein the displaying comprises simultaneously displaying the payment information receiving module and the merchant website within the web browser by embedding the payment information receiving module within the merchant website.

16. The method of claim 8, wherein the displaying comprises simultaneously displaying the payment information receiving module and the merchant website within the web browser by overlaying the payment information receiving module on top of the merchant website.

17. A non-transitory computer readable medium having stored therein instructions that when executed cause a computer to perform a tokenization method of a payment processing server, the method comprising:
receiving payment card information of a cardholder from a payment information receiving module displayed in a web browser of a computing device;
generating a token for the payment card information received from the payment information receiving module; and
transmitting the generated token to a merchant server for a transaction between the merchant and the cardholder,
wherein the payment information receiving module is displayed in the web browser of the computing device in response to a merchant website being displayed therein, and the payment card information is received by the payment processing server, from the payment information receiving module, without being stored by the computing device and without passing through the merchant server.

18. The non-transitory computer readable medium of claim 17, wherein the payment information receiving module comprises at least one of a Lightbox, a floating module, and an iframe.

19. The non-transitory computer readable medium of claim 17, wherein the method further comprises:
receiving, by the payment processing server, a token and a request from the merchant server to distribute funds to the cardholder corresponding to the payment card information;
determining whether the received token matches the generated token; and
processing the distribution request based on the determination.

20. The non-transitory computer readable medium of claim 17, wherein the method further comprises transmitting, to the merchant server, code for installing the payment information receiving module in the merchant website.
